(19) United States
(12) Patent Application Publication
(10) Pub. No.: US 2004/0265623 A1
(43) Pub. Date: Dec. 30, 2004

(54) Conducting polymer for electronic devices

(75) Inventors: Reza Stegamat, Milpitas, CA (US); Franky So, San Jose, CA (US)

Correspondence Address: Siemens Corporation, Attn: Elsa Keller, Legal Administrator, Intellectual Property Department, 170 Wood Avenue South, Iselin, NJ, 08830, US

(73) Assignee: Osram Opto Semiconductors GmbH

(21) Appl. No.: 10/609,262

(22) Filed: Jun. 26, 2003

(51) Int. Cl. B32B 9/00

(52) U.S. Cl. 428/690

(57) ABSTRACT

An embodiment of the present invention pertains to an electronic device that includes a substrate, a first electrode on the substrate, and substantially electrically isolated conducting polymer regions on the first electrode. The substantially electrically isolated conducting polymer regions are formed by selectively depositing a solution that includes water, polyethylenedioxythiophene (“PEDOT”), and polystyrenesulfonic acid (“PSS”), and a ratio of the PEDOT to the PSS is such that the solution has high conductivity.

Alternatively, the substantially electrically isolated conducting polymer regions can be formed by, first, nonselectively depositing the solution to form a continuous conducting polymer layer. Then, the continuous conducting polymer layer is patterned to form the substantially electrically isolated conducting polymer regions.

### BACKGROUND OF THE INVENTION

Electronic devices, as used herein, are devices that include a pair of electrodes (e.g., an anode and a cathode) with at least one semiconductive layer between the electrodes. Examples of electronic devices are passive matrix OLED displays, alpha-numeric OLED displays, OLED light sources used for general purpose lighting, detector arrays, or solar cell arrays. Each of these electronic devices include multiple electronic elements (“elements”). Examples of elements include organic light emitting diodes (“OLEDs”) (the OLEDs can be used in, for example, a display or as light source elements of a light source used for general purpose lighting), organic solar cells, organic transistors, organic detectors, and organic lasers.

In the particular case of the OLED, the OLED is typically comprised of two or more thin organic layers (e.g., an electrically conducting polymer layer and an emissive polymer layer where the emissive polymer layer emits light) separating its anode and cathode. Under an applied forward potential, the anode injects holes into the conducting polymer layer, while the cathode injects electrons into the emissive polymer layer. The injected holes and electrons each migrate toward the oppositely charged electrode and produce an electroluminescent emission upon recombination in the emissive polymer layer.

Each of the OLEDs can be a pixel element in a passive matrix OLED display. FIG. 1 shows an example of a prior art passive matrix OLED display. In FIG. 1, anode strips 112 are on a glass substrate 109. The anode strips 112 are typically made of a transparent material such as indium tin oxide (“ITO”). On the anode strips 112 is a semiconductor stack 115. The semiconductor stack 115 includes at least the following two layers: a conducting polymer layer, and an emissive polymer layer on the conducting polymer layer. Cathode strips 118 are on the semiconductor stack 115. The intersections of the anode strips 112 and the cathode strips 118 together with the semiconductor stack 115 form pixel elements 121. When the difference between the voltage applied to a particular anode strip and the voltage applied to a particular cathode strip is greater than an activation voltage, the pixel element at the intersection of the particular anode strip and the particular cathode strip is illuminated. The light is produced in the emissive polymer layer of that pixel element.

The conducting polymer layer is a p-type material that transports holes effectively to the emissive polymer layer. The conducting polymer layer is also referred to as a hole transport layer (“HTL”). The conducting polymer layer is used to improve, for example, the charge balance, the display stability, the turn-on voltage, the display brightness, the display efficiency, and the display lifetime. The conductivity of this layer is controlled by doping of the polymer layer. By controlling the doping concentration, the conductivity of the layer can be controlled. The conductive polymer layer can be formed from, for example, a solution comprised of water, polyethylenedioxythiophene (“PEDOT”), and polystyrenesulfonic acid (“PSS”) (this solution is referred to, herein, as a PEDOT:PSS solution). This solution is typically deposited by spin coating so that a thin continuous layer of conducting polymer forms on the anode strips 112. The conductivity of the conducting polymer layer is typically kept low to minimize lateral leakage current and cross talk. The lateral leakage current and cross talk results in the emission of light from an unintended pixel element and also results in higher power consumption. Typically, the PEDOT:PSS solution has a ratio of the PEDOT to the PSS of one part by weight of the PEDOT to at least sixteen parts by weight of the PSS. The low conductivity of the conducting polymer layer formed from the PEDOT:PSS solution minimizes the lateral leakage current and the cross talk, however, this is done at the cost of display performance (e.g., if the layer has low conductivity then the display has a greater turn-on voltage, lower brightness, lower efficiency, higher power consumption, and shorter lifetime).

For the foregoing reasons, there exists a need to fabricate an OLED display in which the conducting polymer layer has a high conductivity while the lateral leakage current and cross talk are minimized or eliminated.

### SUMMARY

A first embodiment of an electronic device is described. This electronic device includes a substrate, a first electrode on the substrate, multiple substantially electrically isolated conducting polymer regions on the first electrode, an active electronic layer on the substantially electrically isolated conducting polymer regions, and a second electrode on the active electronic layer. The substantially electrically isolated conducting polymer regions are formed by selectively depositing a solution that includes water, PEDOT, and PSS and a ratio of the PEDOT to the PSS is one part by weight of the PEDOT to at most ten parts by weight of the PSS.

A second embodiment of the electronic device is described. This electronic device includes a substrate, a first electrode on the substrate, multiple substantially electrically isolated conducting polymer regions on the first electrode, an active electronic layer on the substantially electrically isolated conducting polymer regions, and a second electrode on the active electronic layer. The substantially electrically isolated conducting polymer regions are formed by selectively depositing a solution that includes water, PEDOT, and PSS, and each of the substantially electrically isolated conducting polymer regions has a conductivity that ranges from about 1.2×10⁻⁴ S/cm to about 10 S/cm.

A third embodiment of the electronic device is described. This electronic device includes a substrate, a first electrode on the substrate, multiple substantially electrically isolated conducting polymer regions on the first electrode, an active electronic layer on the substantially electrically isolated conducting polymer regions, and a second electrode on the active electronic layer. The substantially electrically isolated conducting polymer regions are formed by nonselectively depositing a conducting polymer material on the first electrode to form a continuous conducting polymer layer on that first electrode. Then, the continuous conducting polymer layer is patterned to form the substantially electrically isolated conducting polymer regions. The conducting polymer material is comprised of water, PEDOT, and PSS. The ratio of the PEDOT to the PSS is one part by weight of the PEDOT to at most ten parts by weight of the PSS, and/or each of the substantially electrically isolated conducting polymer regions has a conductivity that ranges from about 1.2×10⁻⁴ S/cm to about 10 S/cm.

### BRIEF DESCRIPTION OF THE DRAWINGS

FIG. 1 shows an example of a prior art passive matrix OLED display.

FIG. 2 shows an embodiment of a passive matrix OLED display according to the present invention.

FIG. 3 shows a cross-sectional view of an embodiment of an electronic device according to the present invention.

FIG. 4 shows a cross-sectional view of an embodiment of an OLED display according to the present invention.

FIG. 5 is a table that compares the performance of four different sets of OLED displays that each have different PEDOT:PSS ratios.

### DETAILED DESCRIPTION

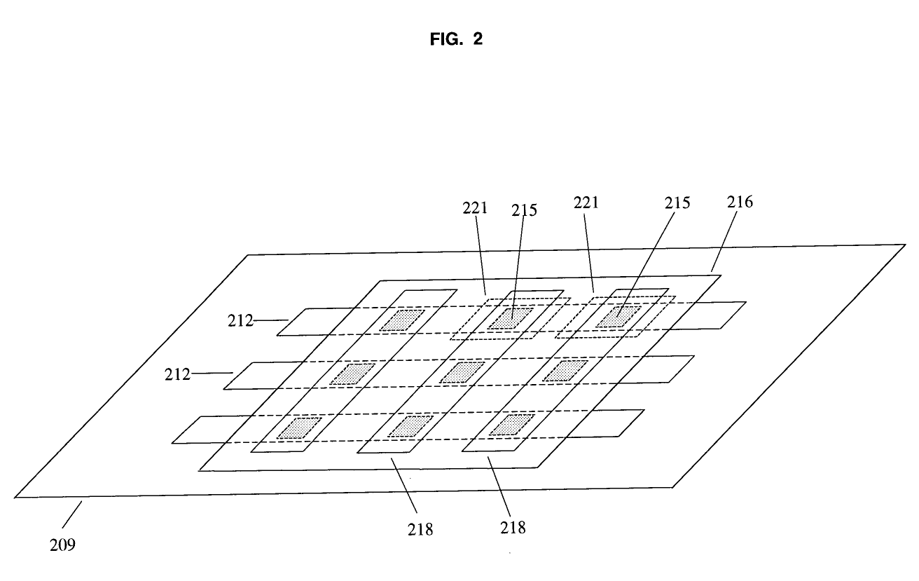

FIG. 2 shows an embodiment of a passive matrix OLED display according to the present invention. In FIG. 2, anode strips 212 are on a substrate 209. As used within the specification and the claims, the term “on” includes when layers are in physical contact and when layers are separated by one or more intervening layers. The anode strips 212 are typically made of a transparent material such as indium tin oxide (“ITO”). On the anode strips 212 are multiple substantially electrically isolated conducting polymer regions 215. An organic light-emitting layer 216 is on the multiple substantially electrically isolated conducting polymer regions 215. Cathode strips 218 are on the organic light-emitting layer 216. The intersections of the anode strips 212 and the cathode strips 218 together with the corresponding conducting polymer regions and the organic light-emitting layer form pixel elements 221.

Each of the substantially electrically isolated conducting polymer regions is formed from a solution that is comprised of water, polyethylenedioxythiophene (“PEDOT”), and polystyrenesulfonic acid (“PSS”), and a ratio of the PEDOT to the PSS is one part by weight of the PEDOT to at most ten parts by weight of the PSS. Preferably, the ratio of the PEDOT to the PSS is one part by weight of the PEDOT to six parts by weight of the PSS. In terms of conductivity, each of the substantially electrically isolated conducting polymer regions has a conductivity that ranges from about 1.2×10⁻⁴ Siemens (“S”)/centimeter (“cm”) to about 10 S/cm. Preferably, the conductivity of each of the regions ranges from about 10⁻³ S/cm to about 10⁻¹ S/cm. The range of thickness of each of the regions is typically from about 10 nanometers (“nm”) to about 500 nm; preferably, from about 30 nm to about 200 nm; and more preferably, from about 50 nm to about 100 nm.

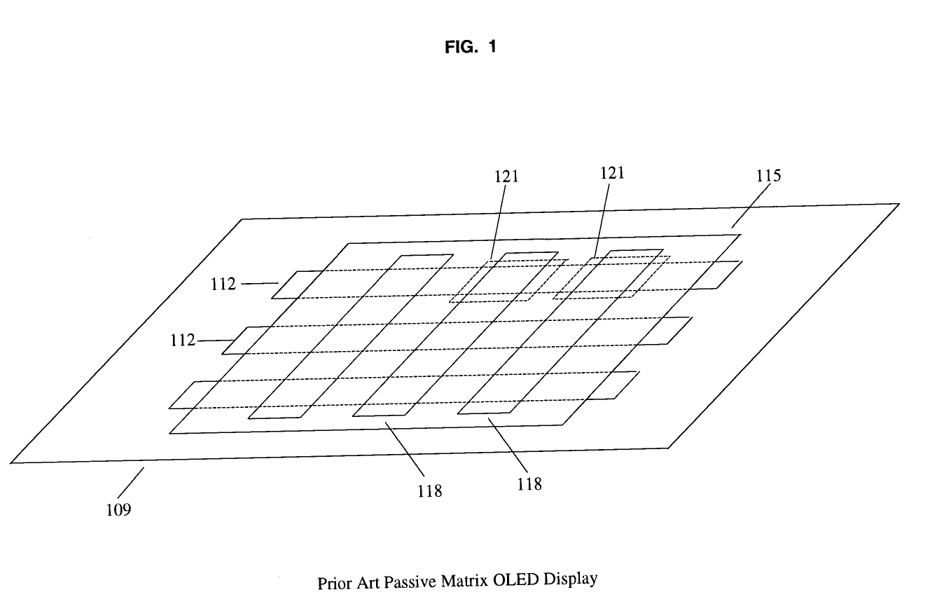

In one embodiment of the present invention, the conducting polymer material (i.e., the conducting polymer material is comprised of the PEDOT:PSS solution with a ratio of the PEDOT to the PSS being one part by weight of the PEDOT to at most ten parts by weight of the PSS) is selectively deposited so as to form the multiple substantially electrically isolated conducting polymer regions 215 on the anode strips 212. The term “selectively deposited” as used herein refers to depositing the material in a manner such that the deposited material is patterned. Examples of selective deposition techniques include, for example: ink jet printing, flex printing, and screen printing. In the prior art shown in FIG. 1, the conducting polymer layer is a continuous film that is uniformly distributed over the entire substrate using, for example, nonselective deposition techniques such as spin-coating. Due in part to being a continuous film, the prior art conducting polymer layer has low conductivity in order to minimize lateral leakage current and cross talk. In this embodiment of the invention, the conducting polymer material is not deposited to form a continuous film, but rather the material is deposited to form noncontinuous substantially electrically isolated regions or islands. Because the conducting polymer regions are noncontinuous, there is no lateral film continuity between the regions and therefore no current leakage occurs laterally. Because there is no lateral film continuity, the conductivity of the conducting polymer material can be increased without compromising display performance due to lateral leaking current and cross-talk. Use of a conducting polymer material with high conductivity results in improved display performance such as improved turn-on voltage, brightness, efficiency, and lifetime.

In an alternative embodiment, the multiple substantially electrically isolated conducting polymer regions 215 are formed by, first, nonselectively depositing the conducting polymer material (i.e., the conducting polymer material is comprised of the PEDOT:PSS with a ratio of the PEDOT to the PSS being one part by weight of the PEDOT to at most ten parts by weight of the PSS) to form a continuous conducting polymer layer on the anode strips 212. Then, the continuous conducting polymer layer is patterned to form the multiple substantially electrically isolated conducting polymer regions 215. The continuous conducting polymer layer is patterned using techniques such as, for example, laser ablation or plasma discharge. The term “nonselectively deposited” as used herein refers to depositing the material in a manner such that a continuous uniform film is formed. Examples of nonselective deposition techniques include, for example, spin coating, dip coating, web coating, and spray coating.

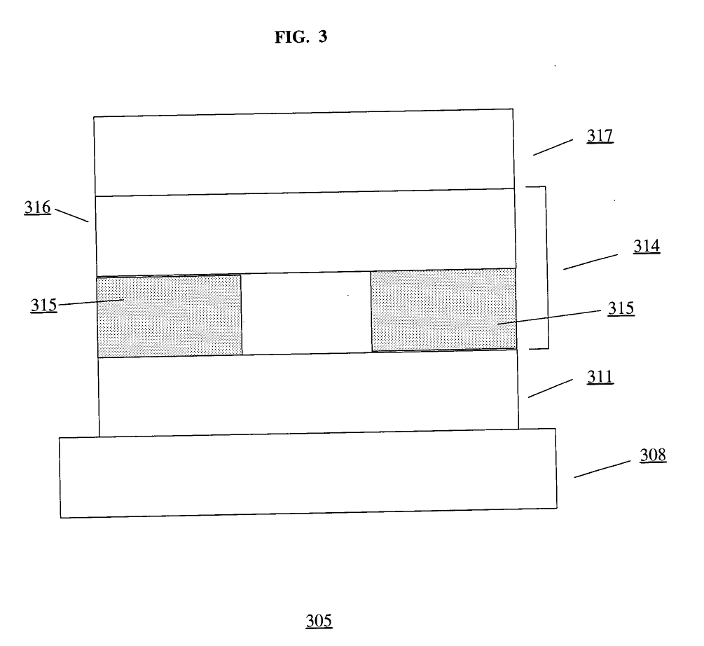

FIG. 3 shows a cross-sectional view of an embodiment of an electronic device 305 according to the present invention. The electronic device 305 includes a substrate 308 and a first electrode 311 on the substrate 308. The first electrode 311 may be patterned for pixilated applications or unpatterned for backlight applications. If the electronic device 305 is a transistor, then the first electrode may be, for example, the source and drain contacts of that transistor. The electronic device 305 also includes a semiconductor stack 314 on the first electrode 311. The semiconductor stack 314 includes at least the following: (1) multiple substantially electrically isolated conducting polymer regions and (2) an active electronic layer. If the first electrode 311 is an anode, then the multiple substantially electrically isolated conducting polymer regions 315 are on the first electrode 311, and the active electronic layer 316 is on the multiple substantially electrically isolated conducting polymer regions 315. Alternatively, if the first electrode 311 is a cathode, then the active electronic layer 316 is on the first electrode 311, and the multiple substantially electrically isolated conducting polymer regions 315 are on the active electronic layer 316. The electronic device 305 also includes a second electrode 317 on the semiconductor stack 314. If the electronic device 305 is a transistor, then the second electrode 317 may be, for example, the gate contact of that transistor. Other layers than that shown in FIG. 2 may also be added including insulating layers between the first electrode 311 and the semiconductor stack 314, and/or between the semiconductor stack 314 and the second electrode 317. These layers are described in greater detail below. Substrate 308:

The substrate 308 can be any material, which can support the layers, and is transparent or semitransparent to the wavelength of light generated in the device. The substrate 308 can be transparent or opaque (e.g., the opaque substrate is used in top-emitting devices). By modifying or filtering the wavelength of light which can pass through the substrate, the color of light emitted by the device can be changed. Preferable substrate materials include glass, quartz, silicon, and plastic, preferably, thin, flexible glass. The preferred thickness of the substrate 308 depends on the material used and on the application of the device. The substrate 356 can be in the form of a sheet or continuous film. The continuous film is used, for example, for roll-to-roll manufacturing processes which are particularly suited for plastic, metal, and metallized plastic foils.

First Electrode 311:

In one configuration of this embodiment, the first electrode 311 functions as an anode (the anode is a conductive layer which serves as a hole-injecting layer and which comprises a material with work function greater than about 4.5 eV). Typical anode materials include metals (such as platinum, gold, palladium, indium, and the like); metal oxides (such as lead oxide, tin oxide, ITO, and the like); graphite; doped inorganic semiconductors (such as silicon, germanium, gallium arsenide, and the like); and doped conducting polymers (such as polyaniline, polypyrrole, polythiophene, and the like).

In an alternative configuration, the first electrode layer 311 functions as a cathode (the cathode is a conductive layer which serves as an electron-injecting layer and which comprises a material with a low work function). The cathode, rather than the anode, is deposited on the substrate 308 in the case of, for example, a top-emitting OLED. Typical cathode materials are listed below in the section for the “second electrode 317”.

The first electrode 311 can be transparent, semi-transparent, or opaque to the wavelength of light generated within the device. Preferably, the thickness of the first electrode 311 is from about 10 nm to about 1000 nm, more preferably from about 50 nm to about 200 nm, and most preferably is about 100.

The first electrode layer 311 can typically be fabricated using any of the techniques known in the art for deposition of thin films, including, for example, vacuum evaporation, sputtering, electron beam deposition, or chemical vapor deposition, using for example, pure metals or alloys, or other film precursors.

Substantially Electrically Isolated Conducting Polymer Region 315:

Each of the substantially electrically isolated conducting polymer regions 315 is formed from a solution that is comprised of water, polyethylenedioxythiophene (“PEDOT”), and polystyrenesulfonic acid (“PSS”), and a ratio of the PEDOT to the PSS is one part by weight of the PEDOT to at most ten parts by weight of the PSS. Preferably, the ratio of the PEDOT to the PSS is one part by weight of the PEDOT to six parts by weight of the PSS. In terms of conductivity, each of the substantially electrically isolated conducting polymer regions has a conductivity that ranges from about 1.2×10⁻⁴ S/cm to about 10 S/cm. Preferably, the conductivity of each of the regions ranges from about 10⁻³ S/cm to about 10⁻¹ S/cm. The range of thickness of each of the regions is typically from about 10 nanometers (“nm”) to about 500 nm; preferably, from about 30 nm to about 200 nm; and more preferably, from about 50 nm to about 100 nm.

The conducting polymer material is either: (1) selectively deposited, or (2) nonselectively deposited and then patterned to form the noncontinuous conducting polymer regions. Because each of the regions is discontinuous from each other, there is no lateral film continuity between the regions and therefore no lateral leakage current between the regions. Examples of selective deposition techniques include, for example, ink jet printing, flex printing, and screen printing. Examples of nonselective deposition techniques include, for example, spin coating, dip coating, web coating, and spray coating. Examples of patterning techniques include, for example, laser ablation and plasma discharge.

Active Electronic Layer 316:

With regards to OLEDs, the active electronic layer 316 is comprised of an organic electroluminescent material. Examples of such organic electroluminescent materials include:

(i) poly(p-phenylene vinylene) and its derivatives substituted at various positions on the phenylene moiety;

(ii) poly(p-phenylene vinylene) and its derivatives substituted at various positions on the vinylene moiety;

(iii) poly(p-phenylene vinylene) and its derivatives substituted at various positions on the phenylene moiety and also substituted at various positions on the vinylene moiety;

(iv) poly(arylene vinylene), where the arylene may be such moieties as naphthalene, anthracene, furylene, thienylene, oxadiazole, and the like;

(v) derivatives of poly(arylene vinylene), where the arylene may be as in (iv) above, and additionally have substituents at various positions on the arylene;

(vi) derivatives of poly(arylene vinylene), where the arylene may be as in (iv) above, and additionally have substituents at various positions on the vinylene;

(vii) derivatives of poly(arylene vinylene), where the arylene may be as in (iv) above, and additionally have substituents at various positions on the arylene and substituents at various positions on the vinylene;

(viii) co-polymers of arylene vinylene oligomers, such as those in (iv), (v), (vi), and (vii) with non-conjugated oligomers; and

(ix) polyp-phenylene and its derivatives substituted at various positions on the phenylene moiety, including ladder polymer derivatives such as poly(9,9-dialkyl fluorene) and the like;

(x) poly(arylenes) where the arylene may be such moieties as naphthalene, anthracene, furylene, thienylene, oxadiazole, and the like; and their derivatives substituted at various positions on the arylene moiety;

(xi) co-polymers of oligoarylenes such as those in (x) with non-conjugated oligomers;

(xii) polyquinoline and its derivatives;

(xiii) co-polymers of polyquinoline with p-phenylene substituted on the phenylene with, for example, alkyl or alkoxy groups to provide solubility; and

(xiv) rigid rod polymers such as poly(p-phenylene-2,6-benzobisthiazole), poly(p-phenylene-2,6-benzobisoxazole), polyp-phenylene-2,6-benzimidazole), and their derivatives.

A preferred organic electroluminescent material that emits yellow light and includes polyphenelenevinylene derivatives is available as PDY132 from Covion Organic Semiconductors GmbH, Industrial park Hoechst, Frankfurt, Germany. Another preferred organic electroluminescent material that emits green light and includes fluorene-copolymers is available as Lumation Green 1300 series from Dow Chemical, Midland, Mich.

Alternatively, rather than polymers, small organic molecules that emit by fluorescence or by phosphorescence can serve as the organic electroluminescent layer. Examples of small-molecule organic electroluminescent materials include: (i) tris(8-hydroxyquinolinato) aluminum (Alq); (ii) 1,3-bis(N,N-dimethylaminophenyl)-1,3,4-oxidazole (OXD-8); (iii) -oxo-bis(2-methyl-8-quinolinato)aluminum; (iv) bis(2-methyl-8-hydroxyquinolinato) aluminum; (v) bis(hydroxybenzoquinolinato) beryllium (BeQ.sub.2); (vi) bis(diphenylvinyl)biphenylene (DPVBI); and (vii) arylamine-substituted distyrylarylene (DSA amine).

Such polymer and small-molecule materials are well known in the art and are described in, for example, U.S. Pat. No. 5,047,687 issued to VanSlyke, and Bredas, J.-L., Silbey, R., eds., Conjugated Polymers, Kluwer Academic Press, Dordrecht (1991).

With regards to solar cells and detectors, the active electronic layer 316 is comprised of a light responsive material that changes its electrical properties in response to the absorption of light. The light responsive material converts light energy to electrical energy.

The thickness of the active electronic layer 316 is from about Snm to about 500 nm, preferably, from about 20 nm to about 100 nm, and more preferably is about 75 nm.

The active electronic layer 316 can be a continuous film that is nonselectively deposited (as shown in FIG. 3), or discontinuous regions that are selectively deposited (not shown).

Second Electrode 317:

In one configuration of this embodiment, the second electrode layer 317 functions as a cathode (the cathode is a conductive layer which serves as an electron-injecting layer and which comprises a material with a low work function). While the cathode can be comprised of many different materials, preferable materials include aluminum, silver, magnesium, calcium, barium, or combinations thereof. More preferably, the cathode is comprised of aluminum, aluminum alloys, or combinations of magnesium and silver.

In an alternative configuration, the second electrode layer 317 functions as an anode (the anode is a conductive layer which serves as a hole-injecting layer and which comprises a material with work function greater than about 4.5 eV). The anode, rather than the cathode, is deposited on the semiconductor stack 314 in the case of, for example, a top-emitting OLED. Typical anode materials are listed earlier in the section for the “first electrode 311”.

The thickness of the second electrode 317 is from about 10 nm to about 1000 nm, preferably from about 50 nm to about 500 nm, and more preferably, from about 100 nm to about 300 nm. While many methods are known to those of ordinary skill in the art by which the second electrode 317 may be deposited, vacuum deposition and sputtering methods are preferred.

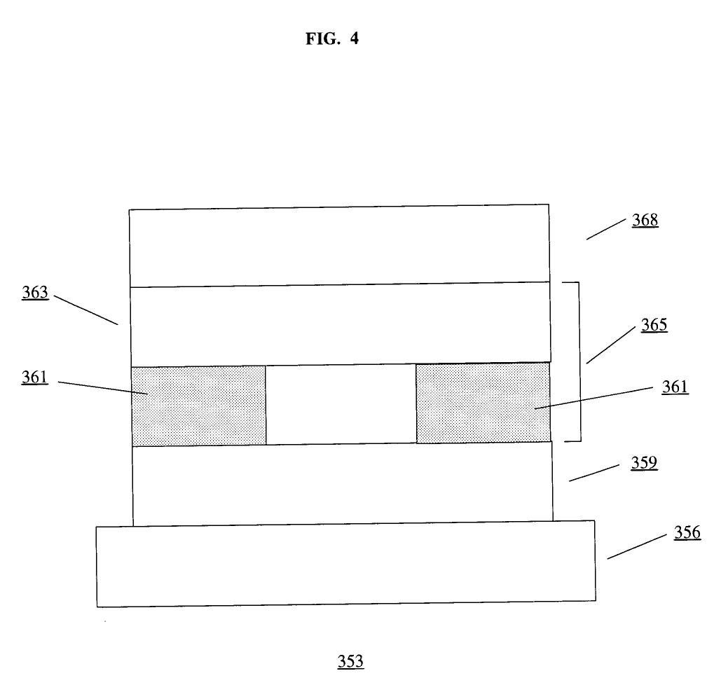

A specific example of an electronic device is an OLED display. FIG. 4 shows a cross-sectional view of an embodiment of an OLED display 353 according to the present invention. The OLED display 353 includes a substrate 356 that may be comprised of, for example, glass or plastic. The OLED display 353 also includes a first electrode 359 on the substrate 356. The OLED display 353 includes a semiconductor stack 365 on the first electrode 359. The semiconductor stack 365 includes at least the following: (1) multiple substantially electrically isolated conducting polymer regions and (2) an organic electroluminescent layer. If the first electrode 359 is an anode, then the multiple substantially electrically isolated conducting polymer regions 361 are deposited on the first electrode 359, and the organic electroluminescent layer 363 is deposited on the multiple substantially electrically isolated conducting polymer regions 361. Alternatively, if the first electrode 359 is a cathode, then the organic electroluminescent layer 363 is deposited on the first electrode 359, and the multiple substantially electrically isolated conducting polymer regions 361 are deposited on the organic electroluminescent layer 363. The OLED display 353 also includes a second electrode 368 on the semiconductor stack 365. These layers were earlier described in greater detail.

### EXAMPLE

The following example is presented for a further understanding of the invention and should not be construed as limiting the scope of the appended claims or their equivalents.

Four different sets of OLED displays were fabricated in the following manner:

(1) For the conducting polymer layer: a first set of OLED displays had PEDOT:PSS solution spun onto ITO-coated glass substrates. For this first set, the PEDOT:PSS solution had a ratio of one part by weight of the PEDOT to six parts by weight of the PSS and a conductivity of 1.5×10⁻³ S/cm. A second set of OLED displays had PEDOT:PSS solution spun onto ITO-coated glass substrates. For the second set, the ratio of the PEDOT to the PSS of this solution was one part by weight of the PEDOT to ten parts by weight of the PSS and a conductivity of 3.5×10⁻⁴ S/cm. A third set of OLED displays had PEDOT:PSS solution spun onto ITO-coated glass substrates. For the third set, the ratio of the PEDOT to the PSS of this solution was one part by weight of the PEDOT to sixteen parts by weight of the PSS and a conductivity of 1.1×10⁻⁴ S/cm. A fourth set of OLED displays had PEDOT:PSS solution spun onto ITO-coated glass substrates. For the fourth set, the ratio of the PEDOT to the PSS of this solution was one part by weight of the PEDOT to twenty parts by weight of the PSS and a conductivity of 5.2×10⁻⁵ S/cm. The PEDOT and the PSS solutions are commercially available from H. C. Starck, located in Goslar, Germany.

(2) For the organic electroluminescent layer: for all four sets, a 70 nm layer of a polyfluorene based blue emitting polymer was deposited on the conducting polymer layer.

(3) For the cathode layer: for all four sets, an electron injecting layer comprised of a 2 nm-thick lithium fluoride layer and a 6 nm-thick calcium layer was evaporated onto the organic electroluminescent layer. Then, for all four sets, a conductive cathode layer comprised of a 200 nm-thick aluminum layer was evaporated onto the electron injecting layer.

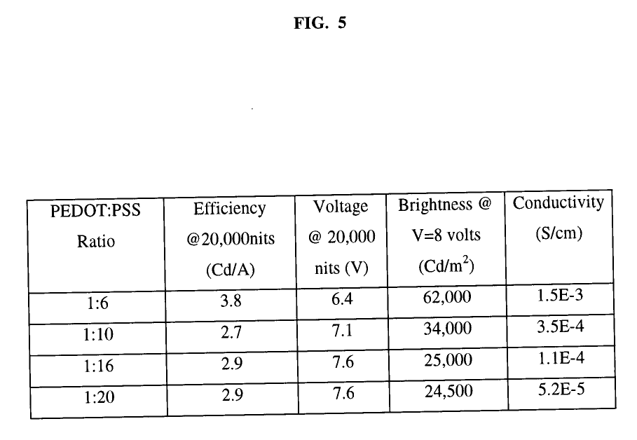

FIG. 5 is a table that compares the performance of the four different sets of OLED displays. As shown in the table, the first set and the second set where the PEDOT to PSS ratio is one part by weight of the PEDOT to at most ten parts by weight of the PSS provide better display performance than the third set and the fourth set. For example, comparing the first set and the fourth set, the efficiency of the first set is about 1.0 Cd/A greater than the fourth set, the drive voltage of the first set is 1.2 volts lower than the fourth set, the brightness of the first set is approximately 2.5 times greater than the fourth set, and the conductivity of the first set is about 30 times greater than the fourth set.

While the embodiments of the substantially electrically isolated conducting polymer regions are illustrated in which it is primarily incorporated within an OLED display, almost any type of electronic device that uses a conducting polymer layer may include these embodiments. In particular, embodiments of the conducting polymer regions of the present invention may also be included in a solar cell, a phototransistor, a laser, a photodetector, or an opto-coupler. The OLED display described earlier can be used within displays in applications such as, for example, computer displays, information displays in vehicles, television monitors, telephones, printers, and illuminated signs.

As any person of ordinary skill in the art of light-emitting device fabrication will recognize from the description, figures, and examples that modifications and changes can be made to the embodiments of the invention without departing from the scope of the invention defined by the following claims.

What is claimed:

1. An electronic device, comprising:
a substrate;
a first electrode on said substrate;
a plurality of substantially electrically isolated conducting polymer regions on said first electrode;
an active electronic layer on said plurality of substantially electrically isolated conducting polymer regions; and
a second electrode on said active electronic layer,
wherein said plurality of substantially electrically isolated conducting polymer regions are formed by selectively depositing a solution that includes water, polyethylenedioxythiophene (“PEDOT”), and polystyrenesulfonic acid (“PSS”), and a ratio of said PEDOT to said PSS is one part by weight of said PEDOT to at most ten parts by weight of said PSS.

2. The electronic device of claim 1 wherein said ratio of said PEDOT to said PSS is one part by weight of said PEDOT to six parts by weight of said PSS.

3. The electronic device of claim 1 wherein said plurality of substantially electrically isolated conducting polymer regions are selectively deposited using any one of the following deposition techniques: ink jet printing, flex printing, or screen printing.

4. The electronic device of claim 1 wherein
said electronic device is an organic light emitting diode (“OLED”) display;
said first electrode is an anode;
said active electronic layer is an organic electroluminescent layer; and
said second electrode is a cathode.

5. The electronic device of claim 4 wherein
said anode is patterned to form a plurality of anode strips; and
said cathode is patterned to form a plurality of cathode strips, said plurality of cathode strips are substantially perpendicular to said plurality of anode strips,
wherein each of a plurality of intersections of said plurality of anode strips and said plurality of cathode strips together with both (1) a corresponding one of said plurality of substantially electrically isolated conducting polymer regions and (2) said organic electroluminescent layer form a substantially electrically isolated pixel.

6. A method to fabricate an electronic device, comprising:
depositing a first electrode on a substrate;
selectively depositing a conducting polymer material on said first electrode to form a plurality of substantially electrically isolated conducting polymer regions on said first electrode;
depositing an active electronic layer on said plurality of substantially electrically isolated conducting polymer regions; and
depositing a second electrode on said active electronic layer,
wherein said conducting polymer material is comprised of water, polyethylenedioxythiophene (“PEDOT”), and polystyrenesulfonic acid (“PSS”), and a ratio of said PEDOT to said PSS is one part by weight of said PEDOT to at most ten parts by weight of said PSS.

7. The method of claim 6 wherein said ratio of said PEDOT to said PSS is one part by weight of said PEDOT to six parts by weight of said PSS.

8. The method of claim 6 wherein selectively depositing said conducting polymer material includes any one of the following deposition techniques: ink jet printing, flex printing, or screen printing.

9. The method of claim 6 wherein
said electronic device is an OLED display;
said first electrode is an anode;
said active electronic layer is an organic electroluminescent layer; and
said second electrode is a cathode.

10. The method of claim 9 further comprising
patterning said anode to form a plurality of anode strips; and
patterning said cathode to form a plurality of cathode strips,
wherein said plurality of cathode strips are substantially perpendicular to said plurality of anode strips, and
wherein each of a plurality of intersections of said plurality of anode strips and said plurality of cathode strips together with both (1) a corresponding one of said plurality of substantially electrically isolated conducting polymer regions and (2) said organic electroluminescent layer form a substantially electrically isolated pixel.

11. An electronic device, comprising:
a substrate;
a first electrode on said substrate;
a plurality of substantially electrically isolated conducting polymer regions on said first electrode;
an active electronic layer on said plurality of substantially electrically isolated conducting polymer regions; and
a second electrode on said active electronic layer,
wherein said plurality of substantially electrically isolated conducting polymer regions are formed by selectively depositing a solution that includes water, polyethylenedioxythiophene (“PEDOT”), and polystyrenesulfonic acid (“PSS”), and each of said plurality of substantially electrically isolated conducting polymer regions has a conductivity that ranges from about 1.2×10⁻⁴ S/cm to about 10 S/cm.

12. The electronic device of claim 11 wherein said conductivity of each of said plurality of substantially electrically isolated conducting polymer regions ranges from about 10⁻³ S/cm to about 10⁻¹ S/cm.

13. The electronic device of claim 11 wherein said plurality of substantially electrically isolated conducting polymer regions are selectively deposited using any one of the following deposition techniques: ink jet printing, flex printing, or screen printing.

14. The electronic device of claim 11 wherein
said electronic device is an organic light emitting diode (“OLED”) display;
said first electrode is an anode;
said active electronic layer is an organic electroluminescent layer; and
said second electrode is a cathode.

15. The electronic device of claim 14 wherein
said anode is patterned to form a plurality of anode strips; and
said cathode is patterned to form a plurality of cathode strips, said plurality of cathode strips are substantially perpendicular to said plurality of anode strips,
wherein each of a plurality of intersections of said plurality of anode strips and said plurality of cathode strips together with both (1) a corresponding one of said plurality of substantially electrically isolated conducting polymer regions, and (2) said organic electroluminescent layer form a substantially electrically isolated pixel.

16. A method to fabricate an electronic device, comprising:
depositing a first electrode on a substrate;
selectively depositing a conducting polymer material on said first electrode to form a plurality of substantially electrically isolated conducting polymer regions on said first electrode;
depositing an active electronic layer on said plurality of substantially electrically isolated conducting polymer regions; and
depositing a second electrode on said active electronic layer,
wherein said conducting polymer material is comprised of water, polyethylenedioxythiophene (“PEDOT”), and polystyrenesulfonic acid (“PSS”), and each of said plurality of substantially electrically isolated conducting polymer regions has a conductivity that ranges from about 1.2×10⁻⁴ S/cm to about 10 S/cm.

17. The method of claim 16 wherein said conductivity of each of said plurality of substantially electrically isolated conducting polymer regions ranges from about 10⁻³ S/cm to about 10⁻¹ S/cm.

18. The method of claim 16 wherein selectively depositing said conducting polymer material includes any one of the following deposition techniques: ink jet printing, flex printing, or screen printing.

19. The method of claim 16 wherein
said electronic device is an OLED display;
said first electrode is an anode;
said active electronic layer is an organic electroluminescent layer; and
said second electrode is a cathode.

20. The method of claim 19 further comprising
patterning said anode to form a plurality of anode strips; and
patterning said cathode to form a plurality of cathode strips,
wherein said plurality of cathode strips are substantially perpendicular to said plurality of anode strips, and
wherein each of a plurality of intersections of said plurality of anode strips and said plurality of cathode strips together with both (1) a corresponding one of said plurality of substantially electrically isolated conducting polymer regions and (2) said organic electroluminescent layer form a substantially electrically isolated pixel.

21. A method to fabricate an electronic device, comprising:
depositing a first electrode on a substrate;
nonselectively depositing a conducting polymer material on said first electrode to form a continuous conducting polymer layer on said first electrode;
patterning said continuous conducting polymer layer to form a plurality of substantially electrically isolated conducting polymer regions on said first electrode;
depositing an active electronic layer on said plurality of substantially electrically isolated conducting polymer regions; and
depositing a second electrode on said active electronic layer,
wherein said conducting polymer material is comprised of water, polyethylenedioxythiophene (“PEDOT”), and polystyrenesulfonic acid (“PSS”), and at least one of: (1) a ratio of said PEDOT to said PSS is one part by weight of said PEDOT to at most ten parts by weight of said PSS, and (2) each of said plurality of substantially electrically isolated conducting polymer regions has a conductivity that ranges from about 1.2×10⁻⁴ S/cm to about 10 S/cm.

22. The method of claim 21 wherein nonselectively depositing said conducting polymer material includes any one of the following deposition techniques: spin coating, dip coating, web coating, or spray coating.

23. The method of claim 21 wherein patterning said continuous conducting polymer layer includes any one of the following patterning techniques: laser ablation or plasma discharge.

24. The method of claim 21 wherein said ratio of said PEDOT to said PSS is one part by weight of said PEDOT to six parts by weight of said PSS.

25. The method of claim 21 wherein said conductivity of each of said plurality of substantially electrically isolated conducting polymer regions ranges from about 10⁻³ S/cm to about 10⁻¹ S/cm.

26. The method of claim 21 wherein
said electronic device is an OLED display;
said first electrode is an anode;
said active electronic layer is an organic electroluminescent layer; and
said second electrode is a cathode.

27. The method of claim 26 further comprising
patterning said anode to form a plurality of anode strips; and
patterning said cathode to form a plurality of cathode strips,
wherein said plurality of cathode strips are substantially perpendicular to said plurality of anode strips, and
wherein each of a plurality of intersections of said plurality of anode strips and said plurality of cathode strips together with both (1) a corresponding one of said plurality of substantially electrically isolated conducting polymer regions and (2) said organic electroluminescent layer form a substantially electrically isolated pixel.

28. An electronic device, comprising:
a substrate;
a first electrode on said substrate;
a plurality of substantially electrically isolated conducting polymer regions on said first electrode;
an active electronic layer on said plurality of substantially electrically isolated conducting polymer regions; and
a second electrode on said active electronic layer,
wherein said plurality of substantially electrically isolated conducting polymer regions are formed by:
nonselectively depositing a conducting polymer material on said first electrode to form a continuous conducting polymer layer on said first electrode, and
patterning said continuous conducting polymer layer to form said plurality of substantially electrically isolated conducting polymer regions, and
wherein said conducting polymer material is comprised of water, polyethylenedioxythiophene (“PEDOT”), and polystyrenesulfonic acid (“PSS”), and at least one of: (1) a ratio of said PEDOT to said PSS is one part by weight of said PEDOT to at most ten parts by weight of said PSS, and (2) each of said plurality of substantially electrically isolated conducting polymer regions has a conductivity that ranges from about 1.2×10⁻⁴ S/cm to about 10 S/cm.

29. The electronic device of claim 28 wherein nonselectively depositing said conducting polymer material includes any one of the following deposition techniques: spin coating, dip coating, web coating, or spray coating.

30. The electronic device of claim 28 wherein patterning said continuous conducting polymer layer includes any one of the following patterning techniques: laser ablation or plasma discharge.

31. The electronic device of claim 28 wherein said ratio of said PEDOT to said PSS is one part by weight of said PEDOT to six parts by weight of said PSS.

32. The electronic device of claim 28 wherein said conductivity of each of said plurality of substantially electrically isolated conducting polymer regions ranges from about 10⁻³ S/cm to about 10⁻¹ S/cm.

33. The electronic device of claim 28 wherein
said electronic device is an OLED display;
said first electrode is an anode;
said active electronic layer is an organic electroluminescent layer; and
said second electrode is a cathode.

34. The electronic device of claim 33 wherein
said anode is patterned to form a plurality of anode strips; and
said cathode is patterned to form a plurality of cathode strips, said plurality of cathode strips are substantially perpendicular to said plurality of anode strips,
wherein each of a plurality of intersections of said plurality of anode strips and said plurality of cathode strips together with both (1) a corresponding one of said plurality of substantially electrically isolated conducting polymer regions and (2) said organic electroluminescent layer form a substantially electrically isolated pixel.
